(19) United States
(12) Patent Application Publication
(10) Pub. No.: US 2014/0226040 A1
(43) Pub. Date: Aug. 14, 2014

(54) IMAGING DEVICE, IMAGING METHOD, AND LIGHT-EMITTING DEVICE

(71) Applicant: SONY CORPORATION, TOKYO (JP)

(72) Inventors: Shunji Okada, Kanagawa (JP); Kumiko Matsuno, Kanagawa (JP); Katsunori Ogawa, Kanagawa (JP); Tomoyuki Mizutani, Kanagawa (JP); Fumito Hiwatashi, Kanagawa (JP); Takaya Konishi, Kanagawa (JP)

(73) Assignee: SONY CORPORATION, TOKYO (JP)

(21) Appl. No.: 14/174,081

(22) Filed: Feb. 6, 2014

(30) Foreign Application Priority Data
Feb. 13, 2013 (JP) 2013-025669

(51) Int. Cl. H04N 5/262; H04N 5/225

(52) U.S. Cl. CPC H04N 5/2621; H04N 5/2256
USPC 348/239

(57) ABSTRACT

An imaging device includes an imaging section and a light-emitting section, and an imaging direction of the imaging section and a direction in which a light is projected by light emission of the light-emitting section are different directions.

### CROSS REFERENCE TO RELATED APPLICATIONS

This application claims the benefit of Japanese Priority Patent Application JP 2013-025669 filed Feb. 13, 2013, the entire contents of which are incorporated herein by reference.

### BACKGROUND

The present disclosure relates to imaging devices, imaging methods, and light-emitting devices.

When an image of a person is taken, an imaging technique that causes a light to exist in a pupil of the person is adopted (see, for example, Japanese Unexamined Patent Application Publication No. 2011-164144). This imaging technique is also called catchlight photographing or the like.

### SUMMARY

To perform catchlight photographing, a dedicated photo studio, a large-scale apparatus such as a screen, and a photographing assistant who holds a light source in a predetermined position are necessary, which makes it difficult to perform catchlight photographing easily. An artificial image which appears as if it was obtained by catchlight photographing can be obtained by using graphic software. However, such an artificial image is obtained by shaping image processing lacking realism, and it takes time and effort to create such an image.

It is desirable to provide an imaging device, an imaging method, and a light-emitting device that make it possible to perform catchlight photographing easily.

According to an embodiment of the present disclosure, there is provided, for example, an imaging device including an imaging section and a light-emitting section, the imaging device in which an imaging direction of the imaging section and a direction in which a light is projected by light emission of the light-emitting section are different directions.

According to an embodiment of the present disclosure, there is provided, for example, an imaging method in an imaging device, wherein a light by light emission of a light-emitting section is projected in a direction which is different from an imaging direction of an imaging section, the light-emitting section emits light with first brightness in accordance with a first operation and a confirmation image obtained via the imaging section is displayed on a display section, and the light-emitting section emits light with second brightness whose level of brightness is higher than the first brightness in accordance with a second operation and an image is obtained via the imaging section nearly synchronously with the light emission.

According to an embodiment of the present disclosure, there is provided, for example, a light-emitting device that is incorporated into an imaging device or can be attached to and removed from the imaging device, the light-emitting device including a light-emitting section that emits light with first brightness in accordance with a first operation which is performed on the imaging device and emits light with second brightness whose level of brightness is higher than the first brightness in accordance with a second operation which is performed on the imaging device.

According to at least one embodiment, catchlight photographing can be performed with ease.

### BRIEF DESCRIPTION OF THE DRAWINGS

FIG. 1 is a diagram for explaining an example of the appearance of an imaging device;

FIG. 2 is a diagram for explaining an example of a first position of a monitor;

FIG. 3 is a diagram for explaining an example of a second position of the monitor;

FIGS. 4A to 4C are diagrams for explaining an example of a light-emitting device;

FIG. 5 is a diagram for explaining an example of the configuration of the light-emitting device;

FIG. 6A is a diagram for explaining video light emission, and FIG. 6B is a diagram for explaining flash light emission;

FIG. 7 is a block diagram for explaining an example of an electrical configuration of the imaging device;

FIG. 8 is a diagram for explaining an example of the configuration of an LED drive control section;

FIG. 9 is a diagram for explaining the position of the user and the position of the imaging device when catchlight photographing is performed;

FIG. 10 is a diagram for explaining a change in the position of an optical image based on video light emission in accordance with an operation performed on the light-emitting device;

FIGS. 11A to 11C are diagrams for explaining a change in the position of an optical image projected on a pupil;

FIG. 12 is a diagram for explaining flash light emission and an imaging operation which is synchronous with the flash light emission;

FIG. 13 is a diagram for explaining an example of the physical positional relationship among the user, the imaging device, and a wall section at the time of catchlight photographing;

FIGS. 14A to 14E are timing charts for explaining an example of processing at the time of catchlight photographing;

FIG. 15 is a sequence chart for explaining an example of processing at the time of catchlight photographing;

FIG. 16 is a diagram for explaining a shape adjusting section;

FIG. 17A is a diagram for explaining an example of the shape adjusting section, and FIG. 17B is a diagram for explaining an optical image projected on a pupil when this shape adjusting section is used;

FIG. 18A is a diagram for explaining another example of the shape adjusting section which is different from the example of the shape adjusting section in FIG. 17A, and FIG. 18B is a diagram for explaining an optical image projected on a pupil when this shape adjusting section is used; and

FIGS. 19A and 19B are diagrams for explaining still another example of the shape adjusting section which is different from the example of the shape adjusting section in FIG. 17A, and FIG. 19C is a diagram for explaining an optical image projected on a pupil when this shape adjusting section is used.

### DETAILED DESCRIPTION OF EMBODIMENTS

Hereinafter, an embodiment of the present disclosure will be described with reference to the drawings. Incidentally, a description will be given in the following order:

1. Embodiment

2. Modified Examples

It is to be understood that the embodiment and so forth which will be described below are preferred examples of the present disclosure, and the contents of the present disclosure are not limited to the following embodiment and so forth.

### 1. Embodiment

### Appearance of an Imaging Device

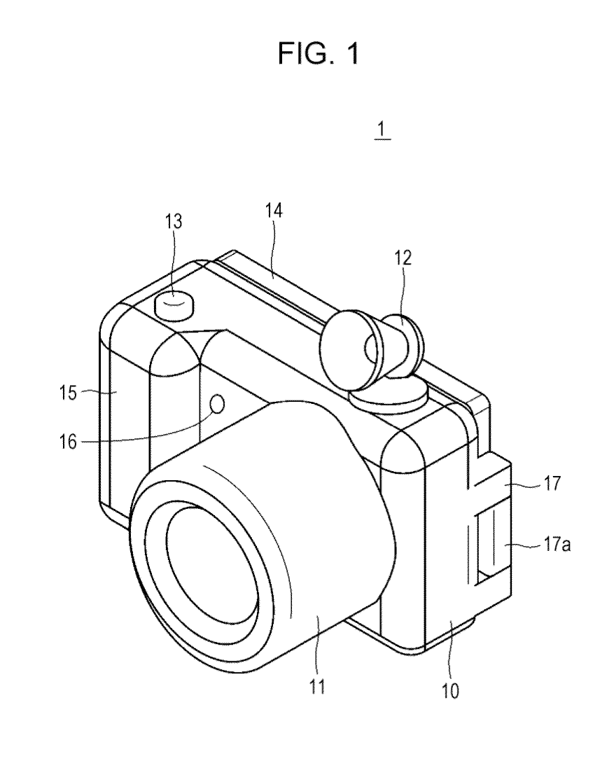

FIG. 1 is a perspective view depicting an example of the appearance of an imaging device of the present disclosure. The imaging device 1 includes, as main component elements, for example, a camera body 10, a lens tube 11 inside which lenses such as an objective lens are disposed, a light-emitting device 12, a shutter button (which is also referred to as a release button) 13, a monitor 14, a grip section 15, and a fill light section 16. The camera body 10 and the monitor 14 are connected to each other via a hinge section 17 with a rotating shaft 17a, for example. The direction in which the objective lens and the like in the lens tube 11 are directed is assumed to be an imaging direction. Incidentally, a structure in which other component elements (for example, a dial switch for switching between modes) are provided in the camera body 10 of the imaging device 1 may be adopted.

The camera body 10 has, for example, a front face, a back face, a top face, a bottom face, a right side face, and a left side face. These expressions that define the directions such as front and back and right and left are provided for the sake of explanation, and the contents of the present disclosure are not limited to these directions. In the front face of the camera body 10, the lens tube 11 and the fill light section 16 are provided. An end of the front face of the camera body 10 slightly projects, and the projecting portion and the right side face of the camera body 10 form the grip section 15. On the back face side of the camera body 10, the monitor 14 is disposed, and the camera body 10 and the monitor 14 are connected to each other by the hinge section 17 formed in the left side face of the camera body 10. In the top face of the camera body 10 near the grip section 15, the shutter button 13 is provided. In an area in the top face of the camera body 10 near the left side face, the light-emitting device 12 is provided.

The lens tube 11 functions as a lens window that takes in a light (an optical image) from a subject. Furthermore, the lens tube 11 also functions as an imaging optical system for guiding the light from the subject to an imaging element disposed inside the camera body 10. The lens tube 11 may be configured such that the lens tube 11 can be detached by the operation performed on a lens replacement button or the like.

The lens tube 11 has a lens group formed of a plurality of lenses that are disposed in order along an optical axis. The lens group includes, for example, a focus lens for focus adjustment and a zoom lens for scaling. As a result of each lens being appropriately driven in an optical axis direction, focus adjustment or scaling is performed. On the periphery of the lens tube 11, a rotatable ring may be formed. The zoom lens moves in the optical axis direction in accordance with the direction and amount of rotation of the ring by manual operation or automatic operation, and a zoom scaling factor in accordance with the position after movement is set. A ring for focus adjustment may be provided in the lens tube 11. The user is allowed to perform manual focusing by moving the lens by rotating the ring.

The light-emitting device 12 includes a light-emitting section. The light-emitting section is formed of a light-emitting diode (LED), for example. The LED may be incorporated into the camera body 10 or may be configured such that the LED can be attached to and removed from the camera body 10 via an attachment section or the like. A circuit (driver) that makes the LED emit light may be incorporated into the light-emitting device 12 or may be incorporated into the camera body 10. The light-emitting device 12 may be configured such that the light-emitting device 12 can be attached to and removed from the camera body 10. The direction in which a light is projected by light emission of the LED of the light-emitting device 12 is assumed to be different from the imaging direction. For example, in catchlight photographing which will be described later, the direction in which a light is projected is assumed be nearly opposite to the imaging direction.

The light-emitting device 12 is used when catchlight photographing is performed, for example. A light by light emission by the LED of the light-emitting device 12 is projected onto a wall surface or the like, and a light (bounce light) reflected from the wall surface or the like is projected on a pupil of a person or the like. The pupil means an area (for example, an area which is called a black eye or the like) other than a white area in an eye. The LED of the light-emitting device 12 is assumed to be able to emit a light with first brightness and a light with second brightness whose level of brightness is higher than the first brightness. In the following description, light emission by the LED with the first brightness is sometimes referred to as video light emission, and light emission by the LED with the second brightness is sometimes referred to as flash light emission. The brightness of the LED is defined by using Lm (lumen) as a unit, for example, but the brightness of the LED may be defined by using other units. Incidentally, the details of the light-emitting device 12 will be described later.

The shutter button 13 is configured as a button that can be brought into a “halfway pressed state” in which the shutter button 13 is pressed halfway and a “fully pressed state” in which the shutter button 13 is pressed all the way down, for example. When the shutter button 13 is pressed halfway, a preparation operation for taking a still image of a subject is performed. Some examples of the preparation operation for taking a still image of a subject include a detection operation for detecting the setting of an exposure control value and detecting a focus and light emission of the fill light section. Incidentally, when the depression of the shutter button 13 is terminated in the halfway pressed state, the preparation operation is ended.

When the shutter button 13 is further pressed after the halfway pressed state and is pressed all the way down, an instruction to perform imaging is given, and an exposure operation related to a subject image (an optical image of the subject) is performed by using the imaging element. An operation by which predetermined image signal processing is performed on the image data obtained by the exposure operation is performed, whereby an image (which will be referred to as the image as appropriate) is obtained. The image data corresponding to the image is stored in a memory card or a storage device such as a hard disk provided in the imaging device 1. The image thus obtained may be displayed on the monitor 14 to allow the user to check whether the image is appropriate or not.

The monitor 14 is formed of a liquid crystal display (LCD), an organic electroluminescence (EL) panel, or the like. On the monitor 14, for example, a menu screen for setting the function of the imaging device 1 and a reproduced image are displayed. Furthermore, when the composition of the subject is determined (framing is performed) before imaging is performed, confirmation images displayed as moving images are displayed on the monitor 14 (live view display).

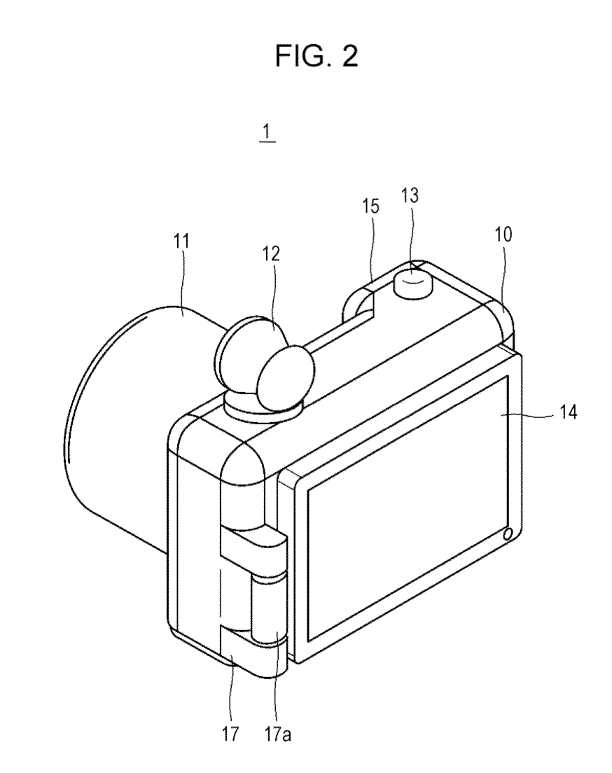

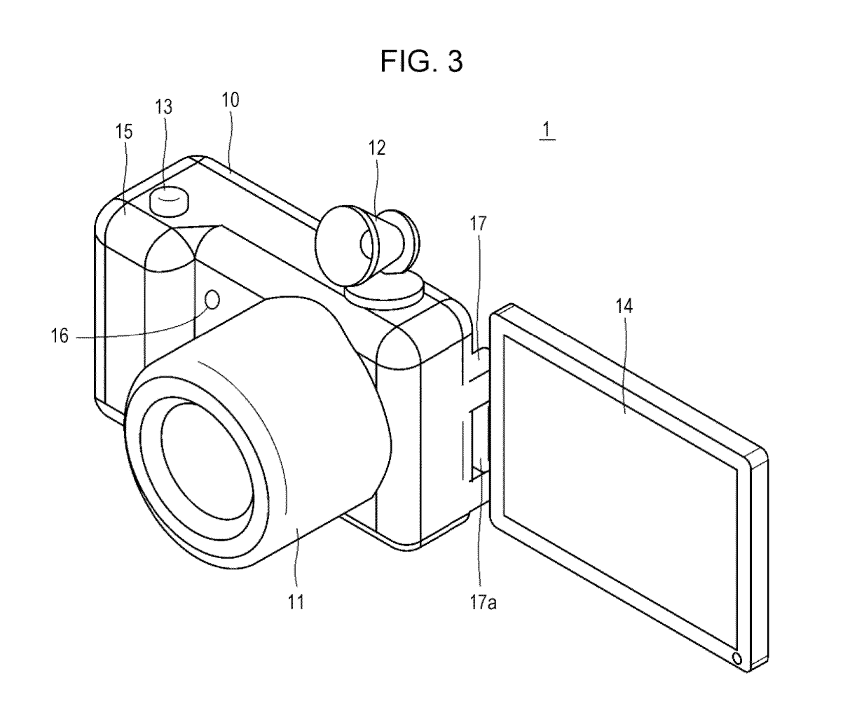

The monitor 14 can be rotated around the rotating shaft 17a of the hinge section 17. At the time of normal imaging, for example, the monitor 14 is disposed in a position (which will be referred to as a first position as appropriate) depicted in FIG. 2. A state in which the monitor 14 is rotated approximately 180 degrees around the rotating shaft 17a from the position depicted in FIG. 2 is depicted in FIG. 3. In a position (which will be referred to as a second position as appropriate) of the monitor 14 in which the imaging direction depicted in FIG. 3 and the direction of display by the monitor 14 nearly coincide with each other, the user can take a picture of him/herself. Moreover, in a state in which the monitor 14 is in the second position, the user can perform catchlight photographing without the necessity of an imaging assistant.

The position of the monitor 14 is not limited to the first and second positions. For example, imaging may be allowed to be performed in a position in which the monitor 14 is nearly perpendicular to the front face and the back face of the camera body 10 by being rotated approximately 90 degrees around the rotating shaft 17a. Furthermore, a structure in which the position of the monitor 14 can be moved such that a display surface by the monitor 14 becomes nearly parallel to the top face or the lower face of the camera body 10 may be adopted.

The grip section 15 is a part that is held by the user of the imaging device 1. To help user's grasp, projections and depressions may be formed on the surface of the grip section 15. Though not depicted in the drawing, for example, a battery storage room and a card storage room are formed inside the grip section 15. In the battery storage room, a battery which is a power source of the imaging device 1 is stored. An example of the battery is a secondary battery such as a lithium-ion secondary battery. It goes without saying that the battery may be a primary battery. In the card storage room, a memory card for storing image data or the like of the taken image is detachably stored. In the grip section 15, a sensor or the like for detecting whether or not the grip section 15 is held may be provided.

The fill light section 16 is provided in a position near the lens tube 11 in the front face of the camera body 10, for example. The fill light section 16 is a general term for, for example, an AF fill light section for performing auto focus (AF) in a dark place, a fill light section used when a close-in shot of a subject is taken, and so forth. When the device is in a state in which the shutter button 13 is pressed halfway, the fill light section 16 may emit light to attract the eyes of a person who is a subject.

The hinge section 17 includes the rotating shaft 17a. As described earlier, the monitor 14 can be rotated around the rotating shaft 17a, whereby the display direction of the monitor 14 can be changed.

### Regarding the Light-Emitting Device

Next, the details of the light-emitting device 12 will be described. The light-emitting device 12 is made movable, for example, and can change the direction in which a light is projected by light emission of a light-emitting element of the light-emitting device 12. Furthermore, the light-emitting device 12 is configured like a projector that can project a strong light in a particular direction, for example.

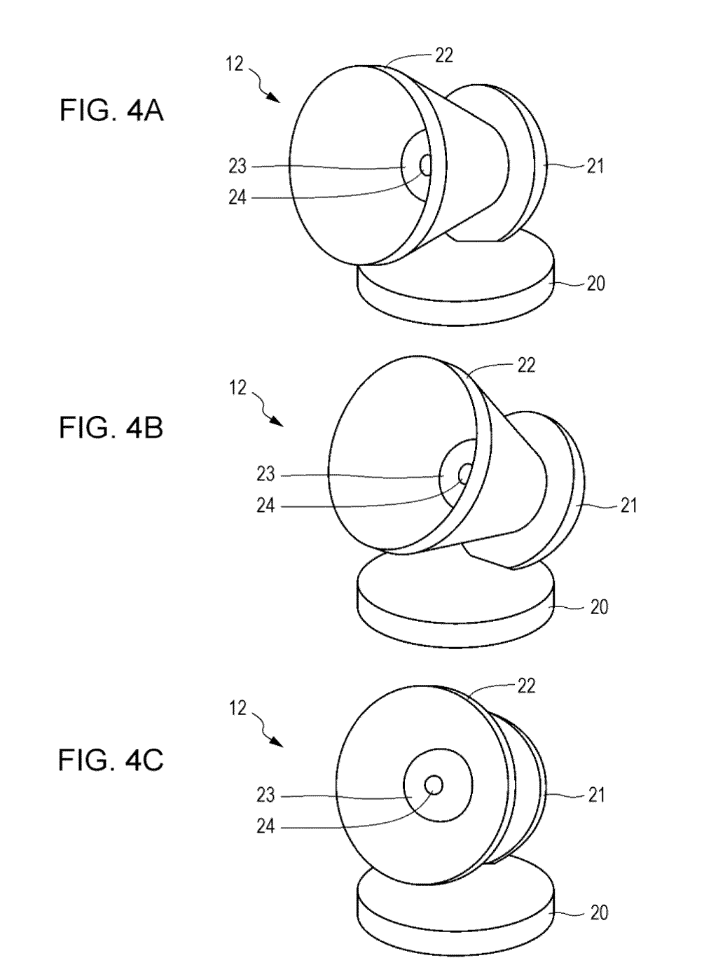

FIG. 4A depicts an example of the configuration of the light-emitting device 12. The light-emitting device 12 has a base 20, and a supporting section 21 is implanted in the base 20. To the supporting section 21, a reflector section 22 having a virtually conical shape is attached. The reflector section 22 has, for example, a condenser lens 23 and an LED 24 at one end inside the reflector section 22 and an opening at the other end. The base 20 is fixed or detachably attached to the top face of the camera body 10. A clip-like attachment section, for example, may be provided in the base 20, and the attachment section may be attached in such a way as to sandwich the camera body 10. This makes it possible to attach the light-emitting device 12 also to the existing imaging device.

Electrical component elements are stored in the base 20 and the supporting section 21, and these electrical component elements are connected to the electrical component elements of the imaging device 1 via contacts. Then, a command for the light-emitting device 12 is supplied from the imaging device 1 via the contacts, whereby the LED 24 is controlled to be turned on or off in accordance with the contents of the command.

The supporting section 21 is made movable in such a way as to be tilted. As schematically depicted in FIG. 4B, by moving the supporting section 21 in such a way as to tilt the supporting section 21, the direction in which a light of the LED 24 is projected in a perpendicular direction (vertical direction) can be changed.

Furthermore, the base 20 has, for example, a bearing rotary structure. With this structure, it is possible to move the supporting section 21 360 degrees in a circumferential direction of the base 20 and change the direction in which a light of the LED 24 is projected in a horizontal direction. Since the direction in which a light of the LED 24 is projected can be changed, it is possible to set the position of an optical image (which will be referred to as a catchlight optical image as appropriate) projected on a pupil at an appropriate position in catchlight photographing.

Incidentally, the user may be allowed to adjust the position of the light-emitting device 12 directly by hand or to adjust the position of the light-emitting device 12 indirectly by using an arrow key or the like. For example, the direction in which a light of the LED 24 is projected may be allowed to be adjusted in a vertical direction by the operation performed on an arrow key (which may be a physical key or may be displayed on the monitor 14 as a touch panel) in a vertical direction, and the direction in which a light of the LED 24 is projected may be allowed to be adjusted in a horizontal direction by the operation performed on the arrow key in a horizontal direction. Furthermore, the light-emitting device 12 may be allowed to move to an appropriate position automatically in accordance with the setting of an imaging mode.

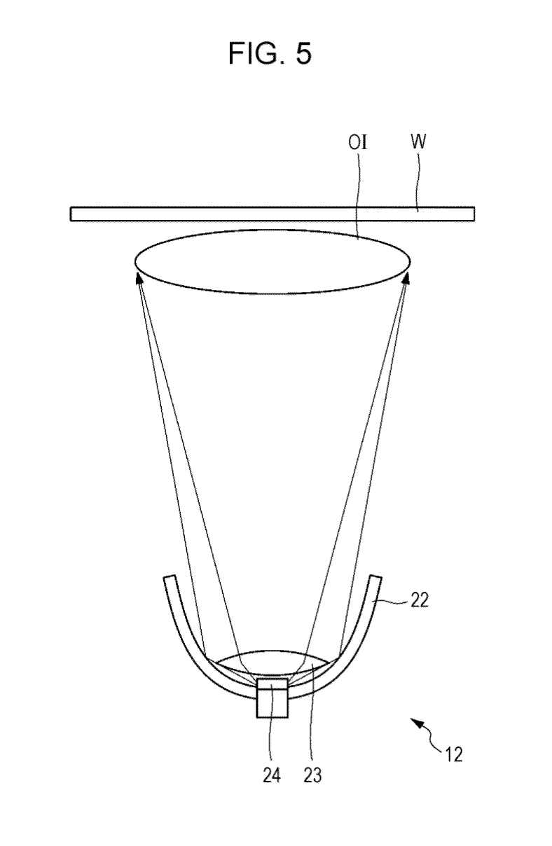

FIG. 5 depicts an example of the layout relationship among individual parts of the light-emitting device 12. In front of the LED 24, the condenser lens 23 is disposed. A light by light emission (surface emission) of the LED 24 is collected by the condenser lens 23 and is reflected from a reflector formed on an inner surface of the reflector section 22 and is collected toward the front of the light-emitting device 12. As the condenser lens 23, for example, a moon lens is used. When the moon lens is used as the condenser lens 23, a nearly circular optical image OI is projected onto a wall surface W in front of the light-emitting device 12. Incidentally, an area in which the optical image OI is projected is not limited to the wall surface, and the area simply has to be a flat surface or a nearly flat surface. Furthermore, by changing the shape of the condenser lens 23, the shape of the optical image OI can be changed.

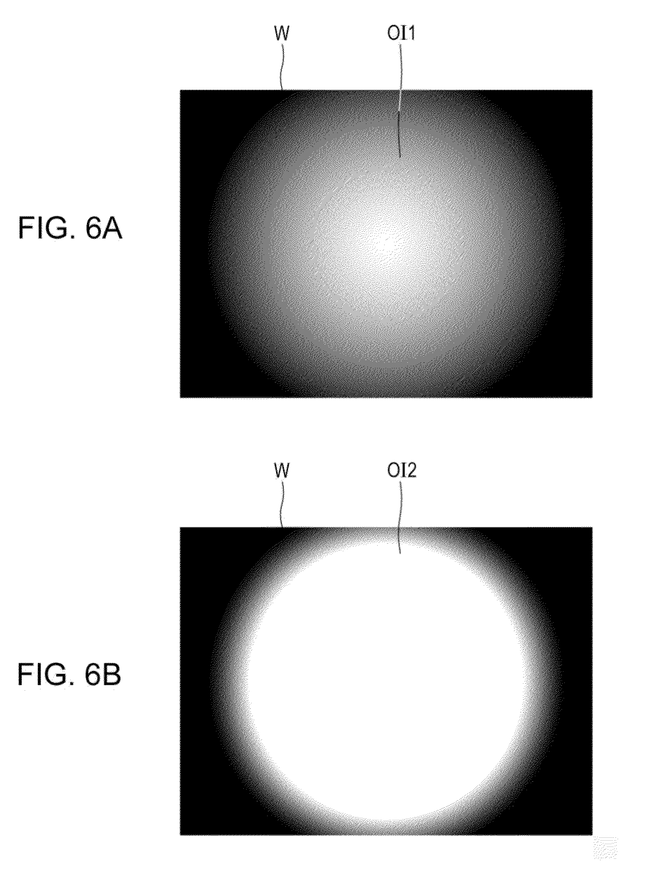

As described earlier, the LED 24 of the light-emitting device 12 emits light by video light emission or flash light emission. Video light emission is performed in a continuous manner, and flash light emission is performed instantaneously. FIG. 6A depicts an example of an optical image (which will be referred to as a video light optical image as appropriate) OI1 based on video light emission. FIG. 6B depicts an example of an optical image (which will be referred to as a flash optical image as appropriate) OI2 based on flash light emission. Incidentally, in FIGS. 6A and 6B, the wall surface W is depicted as a black wall surface to facilitate understanding, but the color of the wall surface W is not necessarily limited to black. In catchlight photographing, the flash optical image OI2 based on flash light emission is projected on a pupil of a person or the like as a catchlight optical image. As described above, since the light-emitting element is made to emit light with different levels of brightness, it is preferable to use an LED whose emission intensity and light-emitting time can be controlled easily as the light-emitting element.

As an example, at the time of video light emission, control by which the drive current of the LED 24 is set at 200 mA (milliamperes) and the LED 24 is made to emit light continuously is performed. At the time of flash light emission, control by which the drive current of the LED 24 is set at between 6 to 12 A and the LED 24 is made to emit light instantaneously is performed. For example, the LED 24 is made to emit light instantaneously for a time from 5 to 33 msec (milliseconds). The emission intensity of flash light emission is set at dozens of times the emission intensity of video light emission, for example.

Incidentally, both the brightness of light emission by video light emission and the brightness of light emission by flash light emission are set to be compliant with class 1 in laser safety standard (IEC60825-1). Therefore, even when the user accidentally looks the light straight in the eye, the eye's retina is not affected, and the device is safe.

### Electrical Configuration of the Imaging Device

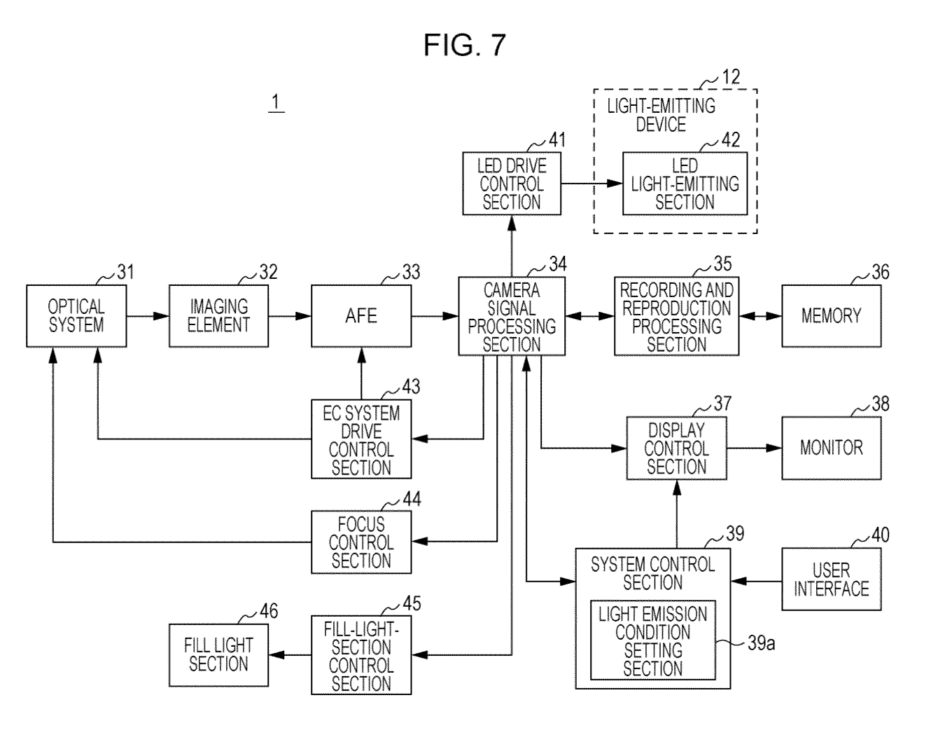

Next, an example of the electrical configuration of the imaging device 1 will be described. FIG. 7 is a block diagram depicting an example of the electrical configuration of the imaging device 1. The imaging device 1 includes, for example, an optical system 31, an imaging element (imager) 32, an analog front end (AFE) 33, a camera signal processing section 34, a recording and reproduction processing section 35, a memory 36, a display control section 37, a monitor 38, a system control section 39, a user interface (UI) 40, an LED drive control section 41, an LED 42, an EC system drive control section 43, a focus control section 44, a fill-light-section control section 45, and a fill light section 46.

Incidentally, the monitor 38 is a component element corresponding to the monitor 14 described earlier. The LED 42 is a component element corresponding to the LED 24 described earlier. The fill light section 46 is a component element corresponding to the fill light section 16 described earlier.

The optical system 31 includes an objective lens, a focus lens, an image stabilization lens, a diaphragm mechanism, and a mechanical shutter mechanism.

The imaging element 32 is formed of a charge coupled device (CCD), a complementary metal oxide semiconductor (CMOS), and the like. The optical system 31 and the imaging element 32 are assumed to be an example of the imaging section. Analog image data is output from the imaging element 32 and is input to the AFE 33.

The AFE 33 includes a noise removing section, a gain control section, an analog to digital (AD) converting section, and so forth. Digital image data is output from the AFE 33 and is input to the camera signal processing section 34. Incidentally, the imaging element 32 and the AFE 33 may be formed as one chip.

The camera signal processing section 34 performs various kinds of camera signal processing on the input digital image data. The camera signal processing section 34 includes, for example, a field angle selecting section, a color reproducing and correcting section that improves color reproduction characteristics, a noise reduction section that performs noise reduction, and a gradation reproducing section that makes the gradation of an image appropriate. These processing blocks perform camera signal processing on the digital image data. It goes without saying that the existing camera signal processing which is different from the processing described above as an example may be performed. When the digital image data is recorded on the memory 36 or the digital image data recorded on the memory 36 is reproduced, the digital image data is exchanged between the camera signal processing section 34 and the recording and reproduction processing section 35.

The recording and reproduction processing section performs processing by which the digital image data is compressed in a predetermined format such as Joint Photographic Experts Group (JPEG) and the compressed digital image data is stored in the memory 36. Furthermore, the recording and reproduction processing section 35 performs processing by which the image data stored in the memory 36 is read and the image data is expanded.

The memory 36 may be a memory, such as a hard disk, which is incorporated into the imaging device 1 or a transportable memory, such as a semiconductor memory, which can be attached to and removed from the imaging device 1. In the memory 36, in addition to a plurality of pieces of digital image data, attribute information (information on the imaging date, the format, etc.) of the digital image data, music data, and so forth are stored.

When the digital image data stored in the memory 36 is reproduced or when live view display or the like is performed, the digital image data on which camera signal processing has been performed by the camera signal processing section 34 is supplied to the display control section 37. The display control section 37 functions as a driver that drives the monitor 38. That is, the display control section 37 converts the input digital image data into video data in a format corresponding to the monitor 38 and supplies the converted video data to the monitor 38 with appropriate timing.

The monitor 38 is formed of an LCD and so forth and displays predetermined video data in accordance with control by the display control section 37.

The system control section 39 is formed of a central processing unit (CPU), a digital signal processor (DSP), read-only memory (ROM) in which a program is stored, a work memory in which data is temporarily stored, and so forth and controls the individual parts of the imaging device 1. A command is supplied to the individual parts of the imaging device 1 from the system control section 39, and the individual parts of the imaging device 1 operate in accordance with the contents of the command. The command output from the system control section 39 is supplied, for example, via the camera signal processing section 34 or directly, to the individual parts.

The system control section 39 has a light emission condition setting section 39a as one of the functions thereof. The light emission condition setting section 39a sets light emission conditions (for example, a drive current and an emission period of the LED 42) of the LED 42 in accordance with a predetermined operation performed on the user interface 40, for example.

The user interface 40 is a general term for a mechanism for an operation which is performed on the imaging device 1. The user interface 40 includes, for example, the above-described shutter button 13. When the monitor 38 is configured as a touch panel, the monitor 38 also functions as the user interface 40. Incidentally, the user interface 40 may be a remote controller that controls the imaging device 1 remotely.

The light emission conditions that are set by the light emission condition setting section 39a of the system control section 39 are supplied to the LED drive control section 41 via the camera signal processing section 34. The LED drive control section 41 is a driver that drives the LED 42. The LED drive control section 41 drives the LED 42 in accordance with the command indicating the light emission conditions sent from the system control section 39. In accordance with the control by the LED drive control section 41, the LED 42 selectively emits light by video light emission and flash light emission.

The LED 42 forming the light-emitting device 12 is formed of one or a plurality of LED elements. When the plurality of LED elements are used, the LED elements may be connected in series. However, since a large power-supply voltage is necessary, preferably, the plurality of LED elements are connected in parallel. The LED 42 is assumed to have a cannonball-like shape, for example, but the LED 42 may have other shapes such as a square shape and a cylindrical shape.

The LED 42 is formed as a white LED, for example. As a method for implementing white by an LED, the existing method can be applied. For example, by encapsulating a blue LED in a yellow fluorescent resin, a white LED can be implemented.

The command sent from the system control section 39 is supplied to the EC system drive control section 43 via the camera signal processing section 34. The individual parts of the EC system drive control section 43 operate in accordance with the command. The EC system drive control section 43 includes, for example, a gain control section, a shutter speed control section, and a diaphragm (iris) control section. The gain control section appropriately controls a gain in the gain control section of the AFE 33. The shutter speed control section appropriately controls the shutter speed by controlling a mechanical mechanism of a shutter included in the optical system 31 with predetermined timing. The diaphragm control section appropriately controls the degree of an aperture by controlling a mechanical mechanism of a diaphragm included in the optical system 31.

The command sent from the system control section 39 is supplied to the focus control section 44 via the camera signal processing section 34. The focus control section 44 operates in accordance with the command. The focus control section 44 drives the focus lens included in the optical system 31 to an appropriate position. As a result, optical automatic focus is implemented.

The fill-light-section control section 45 controls ON and OFF of light emission of the fill light section 46. The fill light section 46 is a general term for an AF fill light section, a fill light section for closeup photography, and so forth.

### Configuration of the LED Drive Control Section

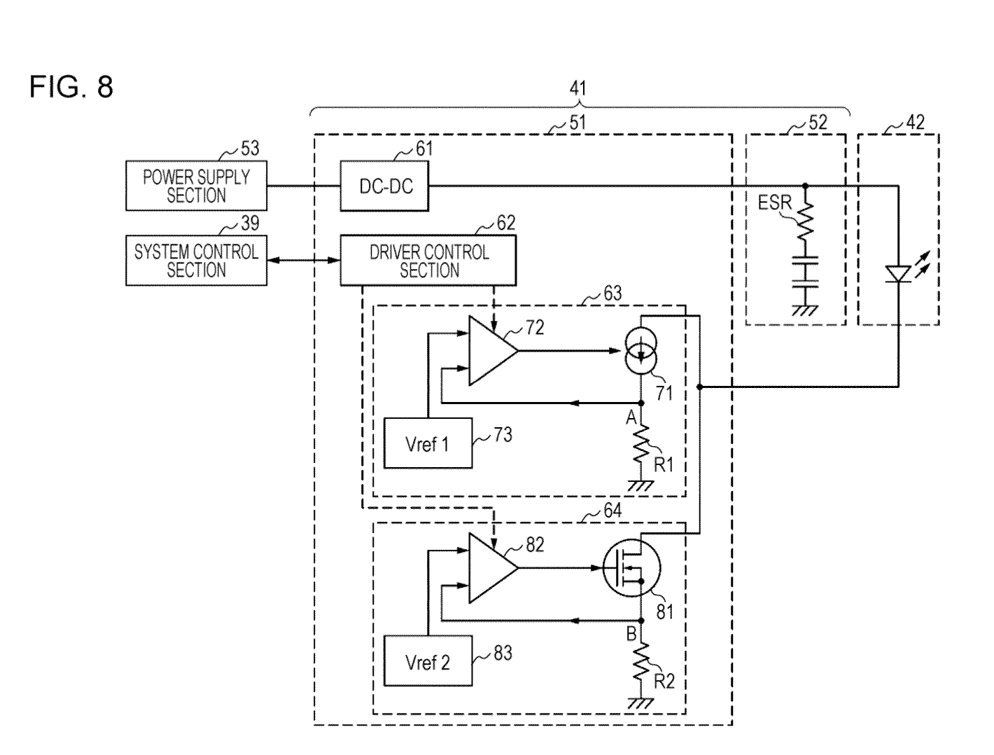

With reference to FIG. 8, an example of the configuration of the LED drive control section 41 will be described. The LED drive control section 41 includes an LED driver 51 and an electric double layer capacitor (EDLC) 52 having an ESR as an internal resistance. The LED driver 51 is connected to the power supply section 53. The power supply section 53 is, for example, a battery that supplies power to the individual parts of the imaging device 1. The anode side of the LED 42 is connected to the electric double layer capacitor 52, and the cathode side of the LED 42 is connected to the LED driver 51.

The LED driver 51 includes, for example, a direct current-direct current (DC-DC) converter 61, a driver control section 62, a constant-current source drive section 63, and a power constant-current source drive section 64. The DC-DC converter 61 converts the output voltage of the power supply section 53 into a predetermined voltage and supplies the voltage after conversion to the electric double layer capacitor 52. As a result, the electric double layer capacitor 52 is charged.

The driver control section 62 is formed of a CPU and so forth and controls the constant-current source drive section 63 and the power constant-current source drive section 64. The driver control section 62 performs, for example, I2C serial communication with the system control section 39. By this communication, a command indicating the light emission conditions of the LED 42 is supplied to the driver control section 62. The driver control section 62 performs switching between the constant-current source drive section 63 and the power constant-current source drive section 64 in accordance with the input command.

When the LED 42 is made to emit light by video light emission, the constant-current source drive section 63 is used. The constant-current source drive section 63 includes, for example, a constant current source 71, a comparator 72, a reference voltage Vref1, and a resistance R1 that is connected in series with the constant current source 71.

When the LED 42 is made to emit light by flash light emission, the power constant-current source drive section 64 is used. The power constant-current source drive section 64 includes, for example, a power constant-current source 81, a comparator 82, a reference voltage Vref2, and a resistance R2 that is connected in series with the power constant-current source 81.

An example of the operation of the LED drive control section 41 will be described. An instruction as to whether the LED 42 is made to emit light by video light emission or flash light emission is given to the driver control section 62 from the system control section 39. In accordance with the instruction from the system control section 39, the driver control section 62 operates the constant-current source drive section 63 or the power constant-current source drive section 64.

When the LED 42 is made to emit light by video light emission, control by which the constant-current source drive section 63 is turned on is performed by the driver control section 62. By this control, the constant current source 71 operates and a constant current flows through the LED 42 by using the voltage of the electric double layer capacitor 52. For example, a current of about 200 mA continuously flows through the LED 42. Incidentally, a voltage V1 at a midpoint (point A) between the constant current source 71 and the resistance R1 is compared with the reference voltage Vref1 by the comparator 72. The voltage V1 is obtained as the product of the current value flowing through the resistance R1 and the resistance R1. When the voltage V1 exceeds the reference voltage Vref1, control by which the constant current source 71 is turned off is performed.

When the LED 42 is made to emit light by flash light emission, control by which the power constant-current source drive section 64 is turned on is performed by the driver control section 62. By this control, the power constant-current source 81 operates and a constant current flows through the LED 42 by using the voltage of the electric double layer capacitor 52. For example, a current of about 10 A instantaneously flows through the LED 42. Incidentally, a voltage V2 at a midpoint (point B) between the power constant-current source 81 and the resistance R2 is compared with the reference voltage Vref2 by the comparator 82. The voltage V2 is obtained as the product of the current value flowing through the resistance R2 and the resistance R2. When the voltage V2 exceeds the reference voltage Vref2, control by which the power constant-current source 81 is turned off is performed.

### Outline of Catchlight Photographing

Next, an example of the outline of catchlight photographing will be described. First, a user U of the imaging device 1 performs an operation for setting the mode of the imaging device 1 at a catchlight photographing mode. This operation is performed by a predetermined operation performed on the monitor 14 formed as a touch panel, for example. In response to the catchlight photographing mode that is set as the mode of the imaging device 1, the light-emitting device 12 emits light by video light emission. On and OFF of light emission of the light-emitting device 12 may be controlled by the operation performed on a button or the like. As a result of the light-emitting device 12 emitting light by video light emission, a video light optical image is projected onto a wall or the like that is located in a direction in which a light is projected from the light-emitting device 12. The video light optical image is assumed to have a virtually circular shape, for example.

The catchlight photographing mode may be automatically set concomitantly with a predetermined operation. For example, a position in which the camera body 10 of the imaging device 1 is held may be detected by a sensor or the like, and, if a predetermined position is held, the catchlight photographing mode may be set automatically. Moreover, the catchlight photographing mode may be set automatically in response to an operation by which the monitor 14 is changed from the first position to the second position. Furthermore, when a mode of taking a picture of the user is set, a display asking whether or not catchlight photographing is performed may be displayed on the monitor 14.

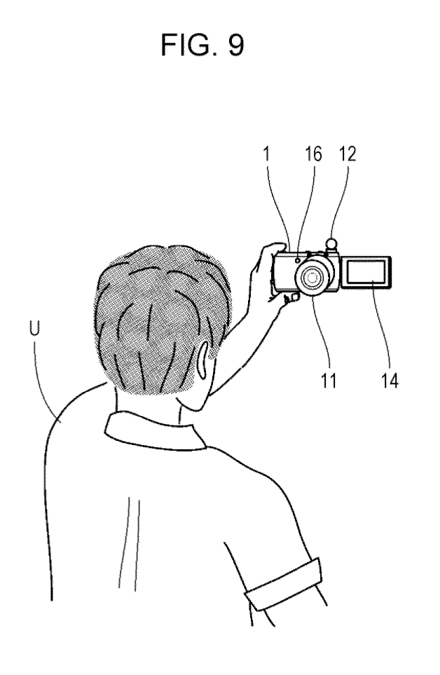

Then, as depicted in FIG. 9, the user U moves the monitor 14 to the second position and points the objective lens in the lens tube 11 at him/herself. On the monitor 14, an image including the user U is displayed by live view display.

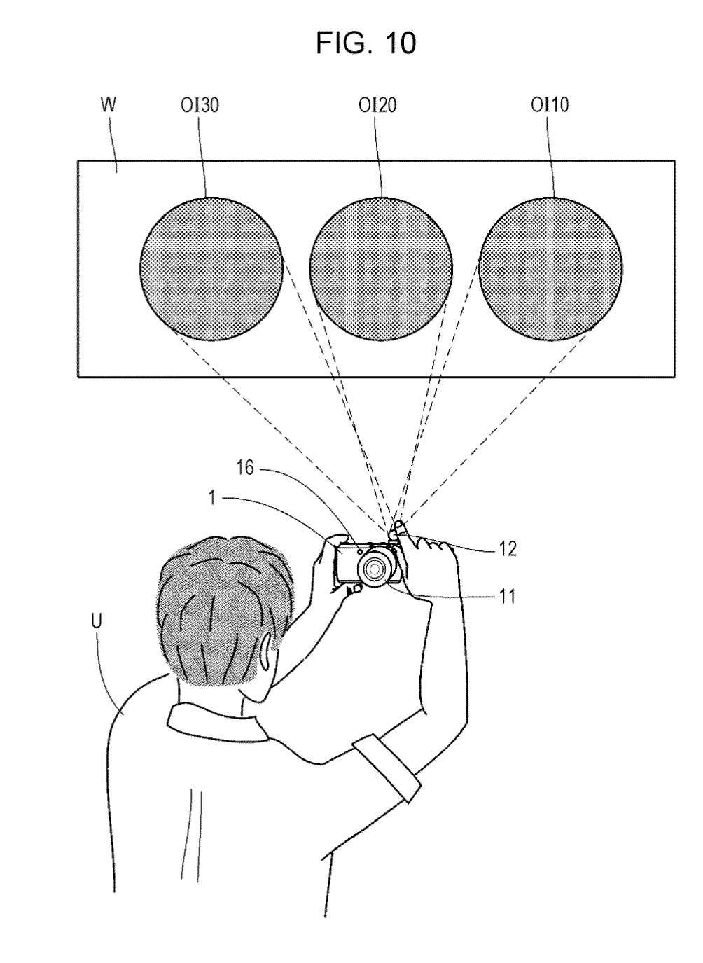

Next, as depicted in FIG. 10, the user U checks the display on the monitor 14 while adjusting the position of the light-emitting device 12 in a perpendicular direction and in a horizontal direction. By switching the position of the light-emitting device 12, the position of the video light optical image projected onto the wall section W can be changed. In FIG. 10, a projection position of the video light optical image when the light-emitting device 12 is moved to the right side of the user U is depicted as an optical image OI10. A projection position of the video light optical image when the direction in which a light is projected from the light-emitting device 12 is set at nearly the front of the user U is depicted as an optical image OI20. A projection position of the video light optical image when the light-emitting device 12 is moved to the left side of the user U is depicted as an optical image OI30.

Incidentally, the video light optical image may be projected onto a flat surface such as a wall section located on the side of the user U, not in front of the user U. When the space is divided by a flat surface including a back face of the imaging device 1, a space (first space) in which an object person (for example, the user U) which is a subject of catchlight photographing exists and a space (second space) in which an object person does not exist are produced. The direction in which a flat surface present in the second space exists is an example of a back face direction of the imaging section, and the light-emitting device 12 simply has to emit light in this direction.

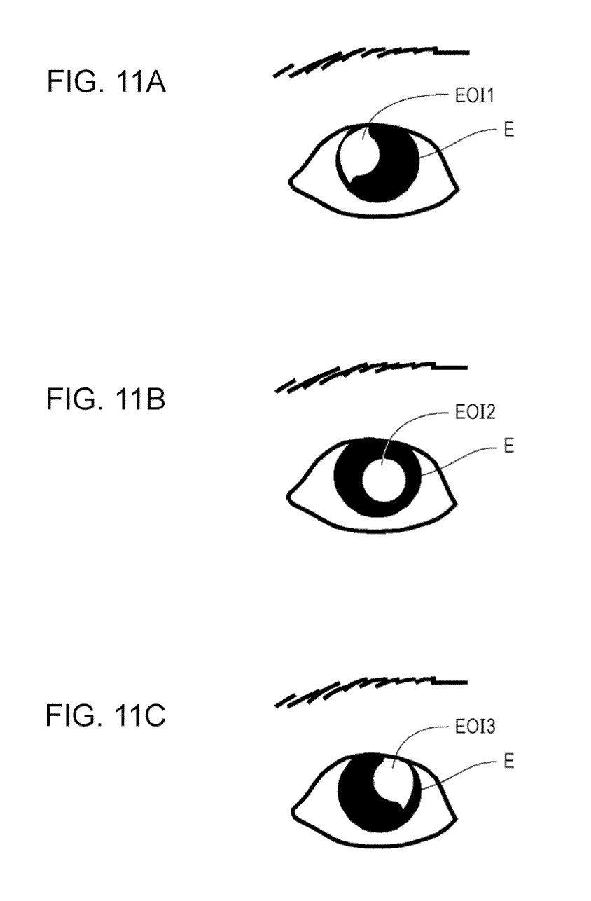

The video light optical image is reflected from the wall section W and the bounce light thereof is reflected on a pupil of the user U. With the adjustment of the position of the light-emitting device 12, the position of the optical image projected on the pupil of the user U that is displayed on the monitor 14 is changed. FIGS. 11A to 11C depict a pupil E of the user U that is displayed on the monitor 14 by live view display and schematically depict the difference in position of an optical image EOI projected on the pupil E. For example, when the position of the video light optical image is the optical image OI10, as depicted in FIG. 11A, an optical image EOI1 projected on the pupil is closer to one end of the pupil E. For example, when the position of the video light optical image is the optical image OI20, as depicted in FIG. 11B, an optical image EOI2 projected on the pupil is located roughly in the center of the pupil E. For example, when the position of the video light optical image is the optical image OI30, as depicted in FIG. 11C, an optical image EOI3 projected on the pupil is closer to the other end of the pupil E.

The user U adjusts the position of the video light optical image by adjusting the position of the light-emitting device 12 while checking the confirmation image displayed on the monitor 14. Since the emission intensity of the LED 24 at the time of video light emission is low, even when the video light optical images are projected successively, the user is not dazzled by the light. Then, the adjustment of the position of the light-emitting device 12 is ended in the position in which the position of the optical image projected on the pupil of the user U has become an intended position. At this time, other adjustments of a composition such as a background may be performed. For example, when the position of the video light optical image is the position of the optical image OI20 (in which the position of the optical image projected on the pupil E is the position of the optical image EOI2), the position adjustment made on the light-emitting device 12 is ended. Incidentally, in parallel with the processing by which the confirmation images are displayed on the monitor 14, preparation processing for performing flash light emission is performed. For example, the electric double layer capacitor 52 is charged. When the charging is completed, the driver control section 62 notifies the system control section 39 of the completion of the charging.

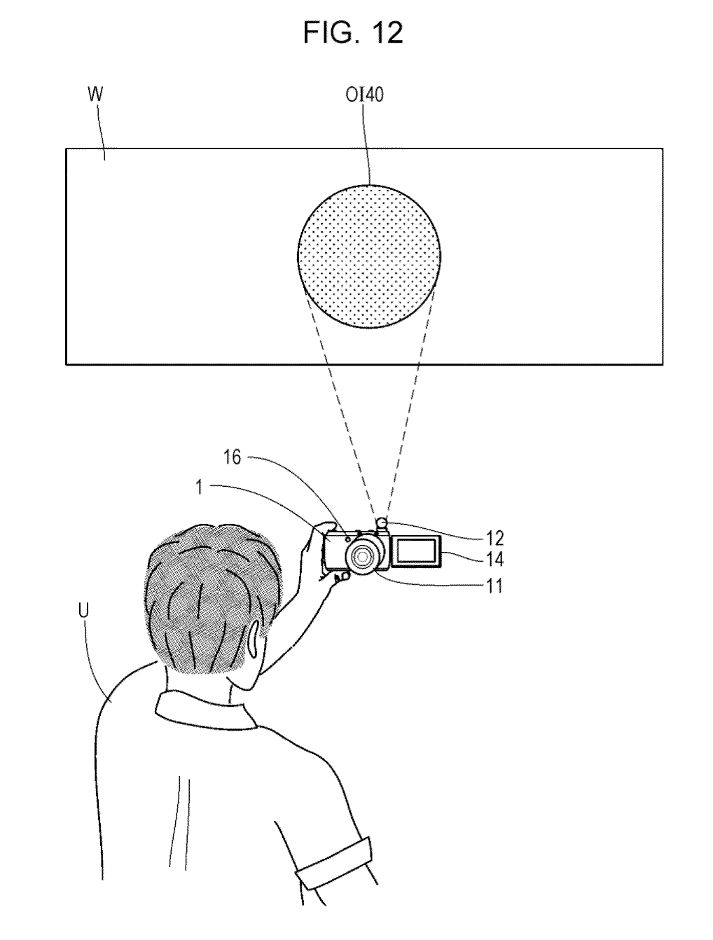

Next, the user U presses the shutter button 13 all the way down. In response to the operation by which the shutter button 13 is pressed all the way down, the light-emitting device 12 emits light by flash light emission. As depicted in FIG. 12, the flash optical image OI40 is projected instantaneously in almost the same position as the video light optical image OI20. The flash optical image OI40 is reflected from the wall section W and the bounce light thereof is reflected on the pupil E of the user U. Furthermore, the imaging operation is performed in response to the operation by which the shutter button 13 is pressed all the way down, and an image is obtained. The image thus obtained includes the face of the user U, and a nearly circular catchlight optical image is projected on the pupil E of the user U in roughly the center thereof.

The fully pressed state of the shutter button 13 is ended and the shutter button 13 is released. The user U checks the image thus obtained on the monitor 14, and, if the image is an intended image, the user U stores the image in the memory 36 or the like. If the user is not satisfied with the image, the user U performs catchlight photographing again in the same manner. Incidentally, the user U is not limited to one person and may be multiple people.

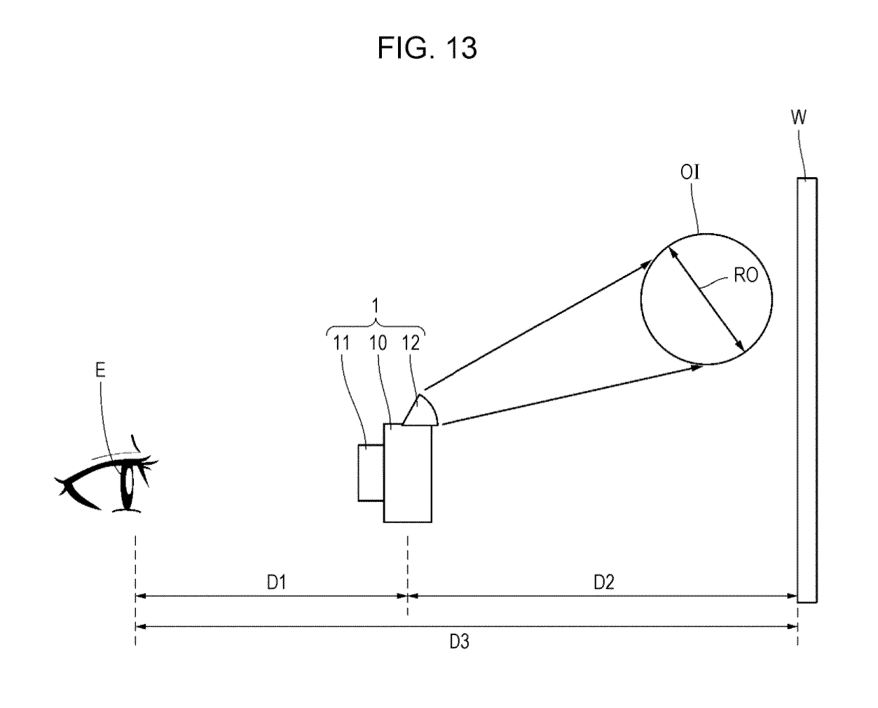

FIG. 13 depicts an example of the physical placement of the individual parts in catchlight photographing. The distance D1 from the pupil E of the user U to the imaging device 1 is set in the range from 20 cm (centimeters) to 30 cm, for example. The distance D2 from the imaging device 1 to the wall section W is set in the range from 20 cm to 50 cm, for example. The distance D3 from the pupil E of the user U to the wall section W is set in the range from 50 cm to 1 m (meter). Although these distances are examples, a large place is not necessary when catchlight photographing is performed.

The diameter RO of the flash optical image having a virtually circular shape is set to be 30 cm to 50 cm, for example. When the diameter of the pupil E is about 10 mm (millimeters), the diameter of the optical image projected on the pupil E is about 5 mm.

Catchlight photographing is performed in the manner as described above as an example. When catchlight photographing is performed, a screen, a large-scale apparatus, an assistant at the time of imaging, and so forth are not necessary. In addition, the user of the imaging device can perform catchlight photographing easily in a place with a wall section or the like irrespective of whether the place is located outside or inside a building.

### Flow of Processing in Catchlight Photographing

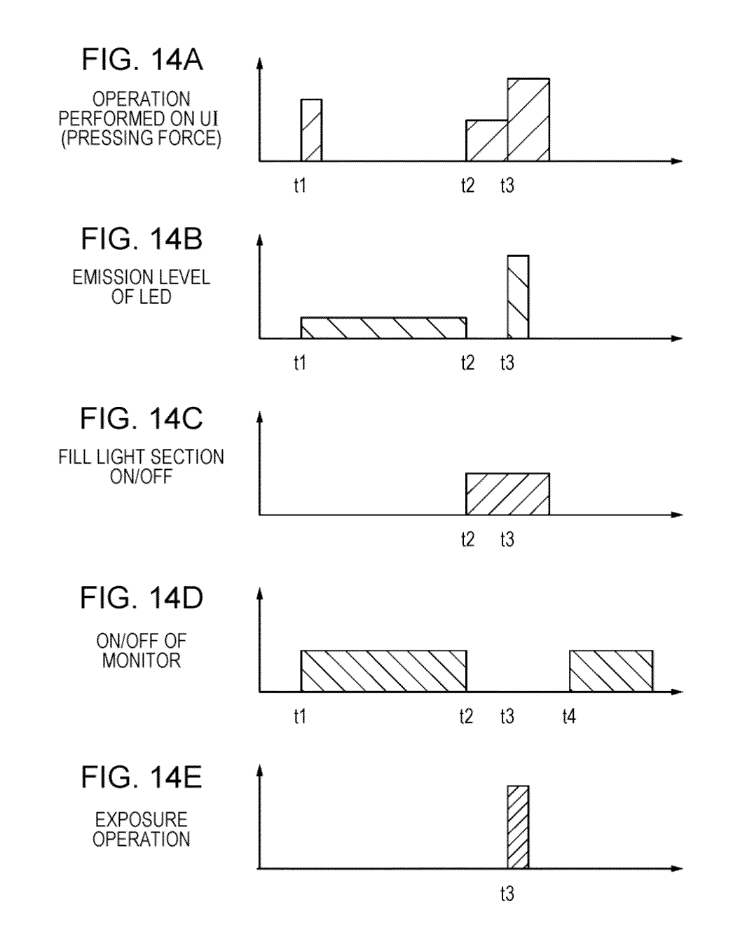

By using timing charts of FIGS. 14A to 14E, an example of processing in catchlight photographing will be described.

The horizontal axes in FIGS. 14A to 14E represent the passage of time. FIG. 14A depicts the presence or absence of an operation performed on the user interface 40. In an operation performed on the shutter button 13 of the user interface 40, the pressing force of the operation is represented by the vertical axis of FIG. 14A. FIG. 14B depicts the presence or absence of light emission of the LED and the emission intensity (emission level). FIG. 14C depicts ON and OFF of the fill light section 16 (for example, the AF fill light section). FIG. 14D depicts ON and OFF of the monitor 14. FIG. 14E depicts the presence or absence of an exposure operation for obtaining the image.

At time t1, an operation performed on the user interface 40 is performed, and the catchlight photographing mode is set as the photographing mode (FIG. 14A). In response to the operation by which the catchlight photographing mode is set as the photographing mode, the LED 24 of the light-emitting device 12 emits light by video light emission (FIG. 14B). Furthermore, on the monitor 14, for example, a subject including the user U of the imaging device 1 is displayed as a confirmation image by live view display (FIG. 14D). Incidentally, the monitor 14 may be turned on before time t1.

In a period from time t1 to time t2, the position of the light-emitting device 12 is adjusted by the user U. The user U adjusts the position of the imaging device 1 and the position of the light-emitting device 12 such that the position or the like of the optical image in the pupil becomes an intended position while checking the confirmation image displayed on the monitor 14.

The composition is determined, and the shutter button 13 is pressed halfway at time t2 (FIG. 14A). In response to the operation by which the shutter button 13 is pressed halfway, the monitor 14 and the LED 24 are turned off (FIG. 14B and FIG. 14D). Furthermore, in accordance with control by the fill-light-section control section 45, the fill light section 16 is turned on (FIG. 14C). The fill light section 16 may be turned on successively or may flash. This control is performed to guide the eyes of an object person of catchlight photographing to the objective lens of the imaging device 1, but this control does not necessarily have to be performed.

At time t3, the shutter button 13 is pressed all the way down (FIG. 14A). In response to the operation by which the shutter button 13 is pressed all the way down, the LED 24 emits light instantaneously by flash light emission (FIG. 14B). The light by flash light emission is projected onto the wall section or the like, and the bounce light thereof is reflected on the pupil of the user U. Furthermore, an exposure operation is performed at the shutter speed which is synchronous with flash light emission, and an image is captured (FIG. 14E). Predetermined camera signal processing is performed on the captured image by the camera signal processing section 34, and the image is obtained. The fill light section 16 is turned off with appropriate timing.

At time t4, the monitor 14 is turned on, and the image is displayed thereon. The user U checks the image thus displayed, and, if the image is an intended image, the user U stores the image data of the image in the memory 36. If the image is not an intended image, the user U discards the image data and performs catchlight photographing again.

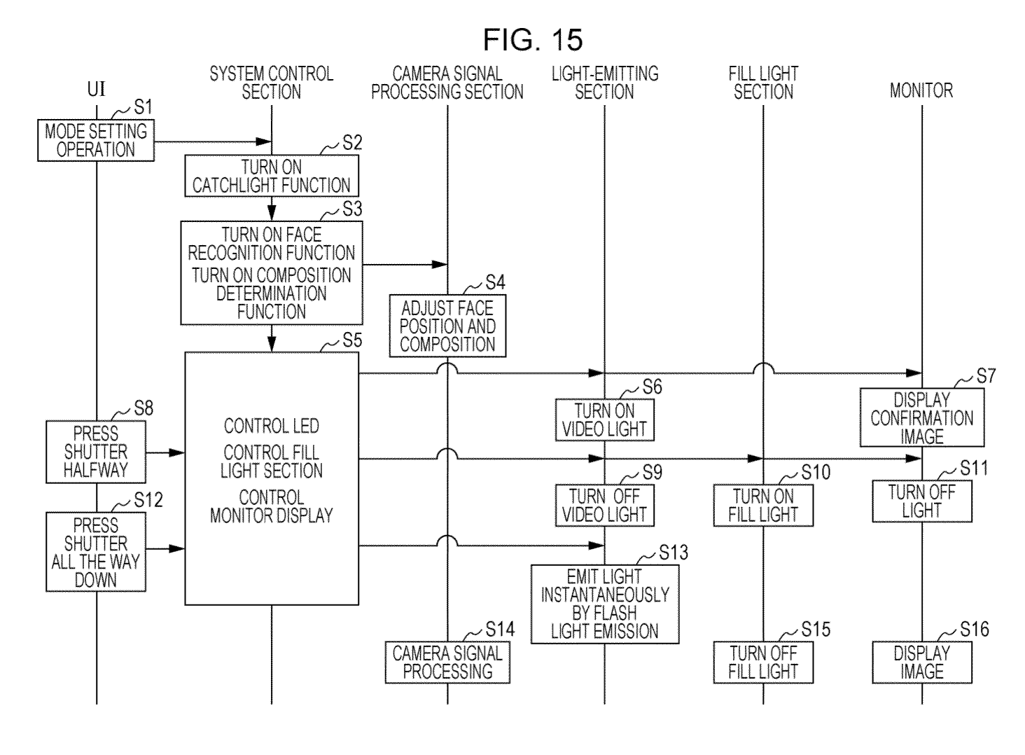

FIG. 15 depicts an example of control sequence in catchlight photographing. An operation for setting the catchlight photographing mode is performed on the user interface 40. Then, the user U points the imaging device 1 at him/herself as depicted in FIG. 9, for example. An operation signal in accordance with the operation by which the catchlight photographing mode is set is supplied to the system control section 39 (step S1). In response to the operation signal, the system control section 39 turns on various functions for performing catchlight photographing (step S2). Examples of the functions will be described one by one.

The system control section 39 generates a command for turning on a face recognition function and a composition determination function and supplies the generated command to the camera signal processing section 34 (step S3). In response to the command, the camera signal processing section 34 performs face recognition, adjustment of the position of the face, and composition determination processing such as enlargement and reduction of the field angle in accordance with the position of the face (step S4). These processing is performed in accordance with a prescribed algorithm.

Then, the system control section 39 controls the LED 24, the fill light section 16, and the monitor 14 (step S5). The light emission condition setting section 39a in the system control section 39 generates a command indicating the conditions of video light emission. This command is supplied from the system control section 39 to the LED drive control section 41. The LED drive control section 41 controls the drive current of the LED 24 in accordance with the command and makes the LED 24 emit light by video light emission (step S6).

Furthermore, the system control section 39 performs control by which the image data on which camera signal processing has been performed by the camera signal processing section 34 is supplied to the display control section 37. Then, the system control section 39 gives, to the display control section 37, an instruction to display the image data on the monitor 14. Here, if the monitor 14 is turned off, control by which power is supplied to the monitor 14 is performed by the system control section 39, and the monitor 14 is turned on. By the control described above, the confirmation image including the user U is displayed on the monitor 14 by live view display (step S7). The user U adjusts the position of the light-emitting device 12 such that the whole composition becomes an intended composition and the position of the optical image reflected on the pupil becomes an intended position while checking the confirmation image.

When the composition is determined, an operation by which the shutter button 13 is pressed halfway is performed (step S8). An operation signal based on this operation is supplied to the system control section 39. The system control section 39 sends, to the LED drive control section 41, a command for turning off the LED 24. In response to the command, the LED drive control section 41 ends the video light emission of the LED 24 and turns off the LED 24 (step S9).

Furthermore, the system control section 39 sends, to the fill-light-section control section 45, a command for turning on the fill light section 16. In accordance with the command, the fill-light-section control section 45 turns on the fill light section 16 (step S10). In addition, the system control section 39 sends, to the display control section 37, a command for turning off the monitor 14. In response to the command, the display control section 37 turns off the monitor 14 (step S11).

Then, the shutter button 13 is pressed all the way down (step S12). An operation signal based on this operation is supplied to the system control section 39. The light emission condition setting section 39a in the system control section 39 generates a command indicating the light emission conditions of flash light emission. This command is supplied from the system control section 39 to the LED drive control section 41. The LED drive control section 41 controls the drive current of the LED 24 in accordance with the command and makes the LED 24 emit light by flash light emission (step S13).

Furthermore, imaging is performed at a shutter speed which is synchronous with the flash light emission of the LED 24. Processing by the AFE 33 is performed on the analog image data obtained via the optical system 31 and the imaging element 32. Camera signal processing by the camera signal processing section 34 is performed on the digital image data on which the processing by the AFE 33 has been performed, whereby an image is obtained (step S14). As a result of imaging which is synchronous with flash light emission, a catchlight optical image is projected on the pupil of the user U in the image. Incidentally, the fill light section 16 that has been turned on in step S10 is turned off with appropriate timing (step S15).

The fully pressed state of the shutter button 13 is ended. The image obtained by imaging is displayed on the monitor 14 (step S16). The user U checks the image displayed on the monitor 14 and checks whether or not the position of the catchlight optical image is an intended position.

Incidentally, though not shown in the drawing, the existing control may be performed in the control sequence described above. For example, control by which automatic focus is implemented may be performed in accordance with an operation by which the shutter button 13 is pressed halfway.

### 2. Modified Examples

Although the embodiment of the present disclosure has been described specifically, the present disclosure is not limited to the above-described embodiment and can be modified in various ways based on the technical idea of the present disclosure.

### Regarding the Shape Correcting Section

For example, the shape of the catchlight optical image projected on the pupil is not limited to a circular shape. An example of a configuration for providing the catchlight optical image with a shape which is different from a circular shape will be described.

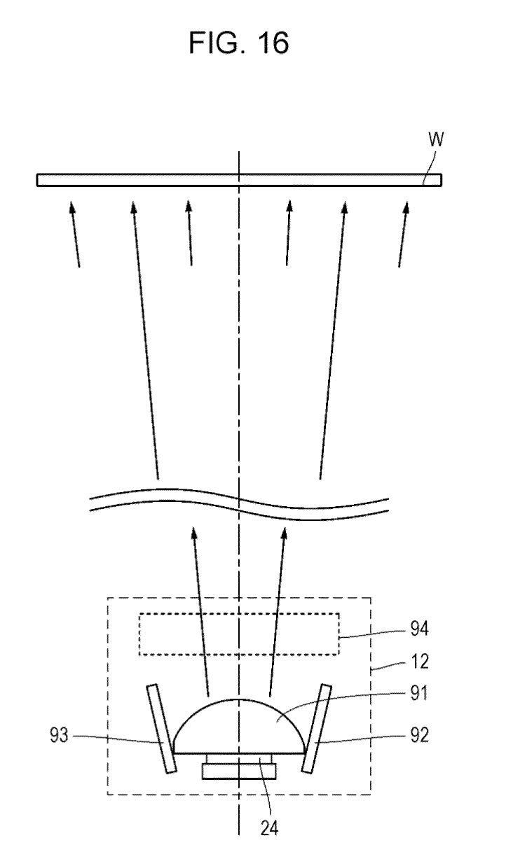

As depicted in FIG. 16, in a direction in which a light of the LED 24 is projected, a condenser lens 91 is disposed. Around the LED 24, reflector sections 92 and 93, each having a reflector on an inner surface, are disposed. The reflector sections 92 and 93 may be provided separately or may be integrally formed to describe a parabola. Furthermore, the light-emitting device 12 is configured such that a shape correcting section 94 is provided in the direction in which a light of the LED 24 is projected. With the shape correcting section 94, the shape of the catchlight optical image can be corrected such that the catchlight optical image has a predetermined shape.

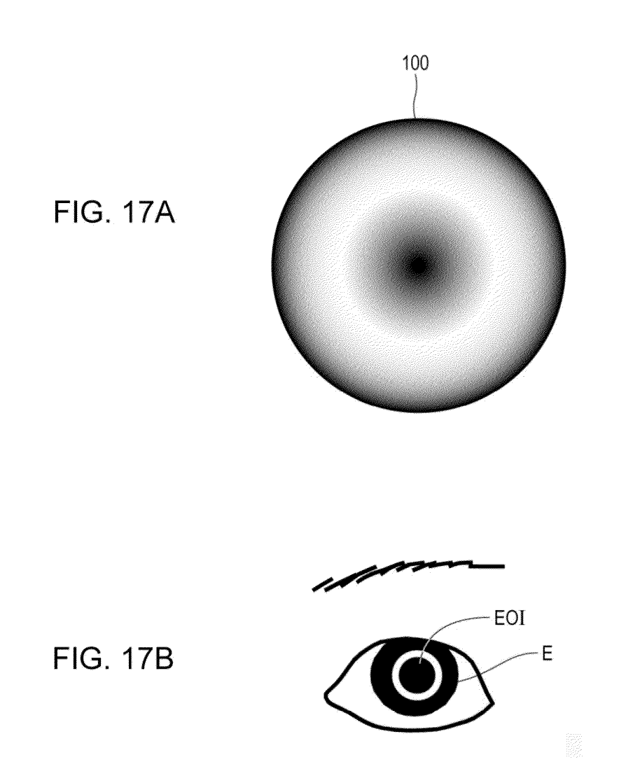

FIG. 17A depicts a lens 100 which is an example of the shape correcting section 94. The lens 100 is formed as, for example, a concentric convex lens. Specifically, the lens 100 is formed as a doughnut-shaped cylindrical convex lens having large curvature (about 500 to 800 mm) in a radius direction, the cylindrical convex lens whose thickness becomes maximum in a point corresponding to one half of the radius thereof, the cylindrical convex lens whose optical axis has an equiangular inclination in a circumferential direction with respect to the central axis. By the light of the LED 24 that has passed through the lens 100, a ring-shaped optical image is projected onto the wall surface of the wall section.

The catchlight optical image EOI which is reflected on the pupil E when the lens 100 is used is shaped like a ring as depicted in FIG. 17B.

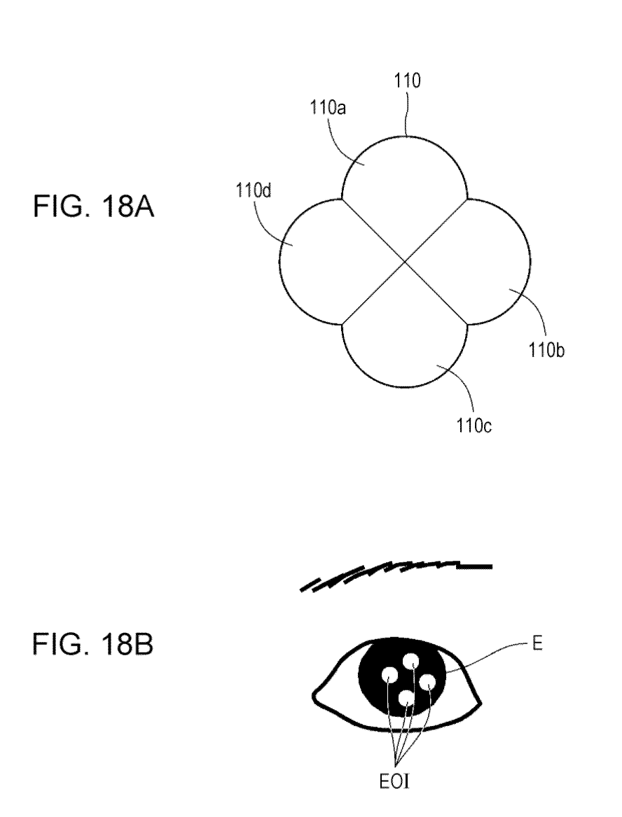

FIG. 18A depicts a lens 110 which is another example of the shape correcting section 94. The lens 110 is formed of four convex lenses (110a, 110b, 110c, and 110d) having large curvature, for example. Specifically, the lens 110 is formed by combining four convex lenses having large curvature (about 500 to 800 mm) in such a way that the convex lenses have an offset inclination in the direction of a cross from the center to the circumference. By the light of the LED 24 that has passed through the lens 110, four optical images having a virtually rectangular shape are projected onto the wall surface of the wall section in the vertical and horizontal directions.

The catchlight optical images EOI which are reflected on the pupil E when the lens 110 is used are four optical images in the vertical and horizontal directions as depicted in FIG. 18B.

By providing the light-emitting device for each of the configurations of the shape correcting section and making it possible to replace the light-emitting device of the imaging device with another light-emitting device, the user can perform catchlight photographing with the user's desired catchlight optical image.

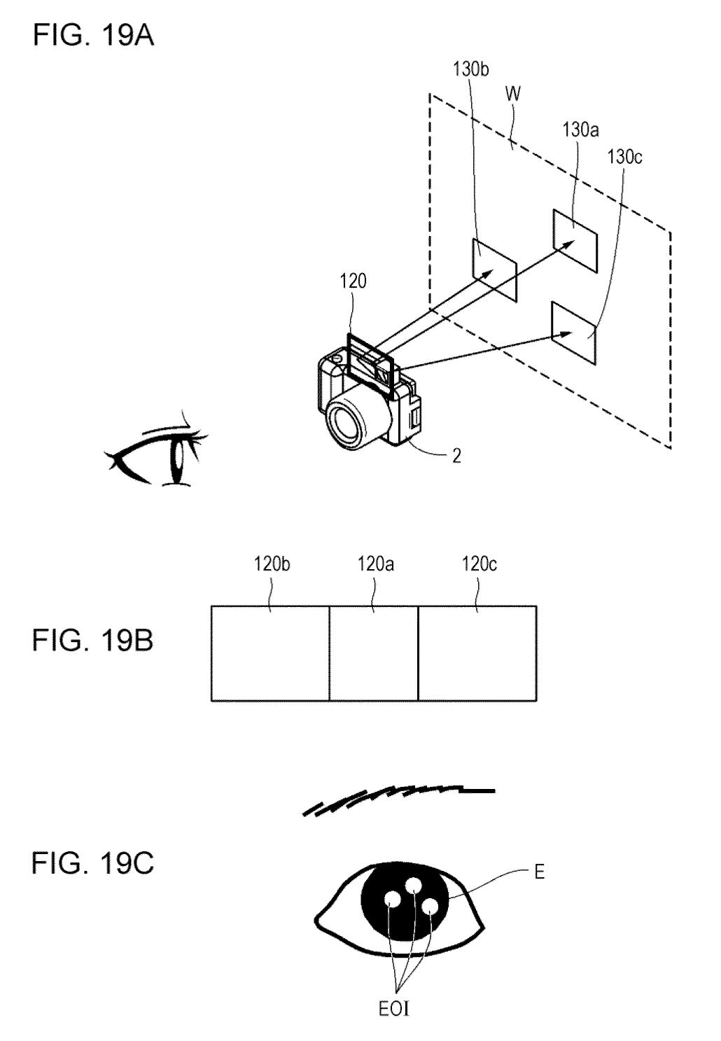

The shape correcting section 94 does not necessarily have to be formed integrally with the light-emitting device 12. The imaging device 2 depicted in FIG. 19A has a pop-up light source formed of at least one of a xenon strobe light and an LED. In front of the light source, a cylindrical concave mirror 120 which is an example of the shape correcting section 94 is disposed.

As depicted in FIG. 19B, the concave mirror 120 is formed of cylindrical concave mirrors 120a, 120b, and 120c obtained by diving a mirror into three. Optical design of the concave mirrors obtained by dividing a mirror into three and the concave mirror curvature providing the concave mirrors with a light collection function is made in such a way as to attain a lighting light distribution with which a xenon strobe light light-emitting section illuminates a flat surface within an imaging field angle range about 1 m ahead at the time of normal photographing by xenon strobe light emission. Furthermore, an optical design of the radius of curvature is made in such a way that, at the time of catchlight photographing, an emission light pencil emitted from the front face of the xenon strobe light is reflected from the concave mirrors obtained by dividing a mirror into three in a direction opposite to the direction in which the objective lens faces and the light is collected on a closer wall surface (about 0.5 m ahead). As a result, it is possible to implement concave mirrors by which three optical images having a virtually rectangular shape are formed by collection of light.

The middle concave mirror 120a is disposed in such a way as to face slightly upward (for example, about 20 degrees) with respect to the optical axis. The concave mirrors 120b and 120c on both sides of the concave mirror 120a are disposed in such a way as to form approximately 90 degrees with respect to the optical axis. As a result of this angle setting, three light spots having a virtually rectangular shape are projected onto the wall surface, and an optical image having a chevron shape in which the middle light spot is located at the top is projected onto the wall surface. A bounce light based on this optical image is reflected on the pupil of the user as a catchlight optical image.

Incidentally, by providing a micro-electro-mechanical systems (MEMS) element for each concave mirror and driving each concave mirror by using the MEMS element, an up-and-down reflection angle by the concave mirrors can be changed. A design in which the three optical images projected onto the wall surface are aligned from top left to bottom right or from top right to bottom left, for example, can also be implemented by performing control by which the angle is changed in a single-axis direction or a biaxial direction by driving the concave mirrors.

The concave mirror 120 is attached to the lens tube 11 by being fitted thereinto by an attachment section or the like. The attachment section is formed of a polymeric material (such as plastic) having reversible elasticity, for example, and has a ring-like shape. By the light reflected from the concave mirror 120, three optical images (130a, 130b, and 130c), for example, are projected onto the wall surface W.

The catchlight optical images EOI which are reflected on the pupil E when the concave mirror 120 is used are three optical images as depicted in FIG. 19C. The position of each optical image can be changed by adjusting the position of each concave mirror.

A configuration in which a concave-mirror light collecting mirror having a parabolic shape is disposed from the back face to the vertical sides faces of a xenon strobe light arc tube having a linear phosphor in a transverse direction and a Fresnel lens is disposed on the front face of the xenon strobe light arc tube may be adopted. By disposing the Fresnel lens, it is possible to make striped, patchy light emission uniform, the striped, patchy light emission at the time of emission of a xenon strobe light. Since a strobe light flashes by high-voltage driving (for example, 4 kV), safety has to be taken into consideration. Therefore, it is preferable not to adopt a configuration in which the xenon strobe light arc tube itself is rotated in a direction opposite to the direction of the lens of the imaging device. Moreover, by disposing the above-described concave-mirror light collecting mirror in front of the light-emitting section of the xenon strobe light arc tube, it is possible to project three optical images in a direction opposite to the objective lens of the imaging device (toward the wall surface in front of the photographer).

### Other Modified Examples

In the embodiment described above, the operator of the imaging device coincides with the object person of catchlight photographing, but the operator of the imaging device does not necessarily coincide with the object person of catchlight photographing. Moreover, the user performs catchlight photographing by holding the imaging device in his/her hand; instead, for example, the imaging device may be fixed to a tripod, and the user may control the position of the light-emitting device and the operation of the imaging device by using a remote-control apparatus.

In the embodiment described above, the monitor of the imaging device is made to move in a horizontal direction around the rotating shaft of the hinge section, but a configuration in which the monitor of the imaging device moves in a perpendicular direction may be adopted. Moreover, a mechanism that makes the monitor movable is not limited to a hinge. The monitor may slide in a vertical direction, for example. A configuration in which the monitor of the imaging device is fixed and another monitor and a mirror are provided on the side of the imaging device where the front face is located may be adopted. The position of the light-emitting device is not limited to the top face of the camera body and may be any appropriate position. Incidentally, the position of the monitor at the time of catchlight photographing is set at a position in which the monitor does not block the optical path of the light of the LED, the position corresponding to the position of the light-emitting device.

As the light-emitting section in the light-emitting device, preferably, an LED is used, but a strobe light may be used. Moreover, a configuration in which two lights: an LED and a strobe light are used may be adopted. In this case, an LED drive circuit and a drive circuit for strobe light emission are provided in the imaging device. Then, switching between the drive circuits is performed; video light emission is performed by using the LED and flash light emission is performed by using the strobe light. The drive circuit for strobe light emission may adopt a single voltage system or a double voltage system, and the existing drive circuit can be used.

The LED may be made to emit light with brightness which is different from the first brightness and the second brightness. By controlling the drive current of the LED, the emission intensity of the LED can be changed appropriately. Moreover, the LED may be used as a flash at the time of normal photographing.

By detecting the position of the catchlight optical image and the position of the pupil in an image, a direction in which the position of the light-emitting device is adjusted such that the catchlight optical image is located in a predetermined position (for example, the center) of the pupil may be guided. The direction in which the position of the light-emitting device is adjusted may be guided by a display on the monitor, sound, or a combination of the display and the sound.

The imaging device in the embodiment of the present disclosure may be an imaging device provided in a cellular telephone, a smartphone, a tablet computer, and so forth. The object person of catchlight photographing is not limited to a human being and may be an animal.

Furthermore, the present disclosure is not limited to a device and can be implemented as a method, a program, and a recording medium in which a program is recorded.

Incidentally, the configurations and processing in the embodiment and the modified examples can be combined as appropriate unless a technical contradiction arises. The sequence of each processing in the flow of the processing described as an example can be changed as appropriate unless a technical contraction arises.

The present disclosure can also be applied to a so-called cloud system in which the processing described as an example is performed by being distributed in a plurality of devices. The present disclosure can be implemented as a system in which the processing described as an example in the embodiment and the modified examples is executed and a device in which at least part of the processing described as an example is executed.

The present disclosure can adopt the following configuration.

(1) An imaging device including an imaging section and a light-emitting section, in which an imaging direction of the imaging section and a direction in which a light is projected by light emission of the light-emitting section are different directions.

(2) The imaging device described in (1), in which the light-emitting section emits light with first brightness or second brightness whose level of brightness is higher than the first brightness.

(3) The imaging device described in (2), in which the light-emitting section emits light with the first brightness in accordance with a first operation and emits light with the second brightness in accordance with a second operation.

(4) The imaging device described in (3), in which the first operation is an operation for setting a predetermined mode and the second operation is an operation for giving an instruction to perform imaging.

(5) The imaging device described in (4), in which the predetermined mode is a catchlight photographing mode and the operation for giving an instruction to perform imaging is an operation by which a shutter button is pressed.

(6) The imaging device described in any one of (1) to (5), in which the light-emitting section is turned off in response to an operation by which the shutter button is pressed halfway during light emission with the first brightness.

(7) The imaging device described in (5) or (6), the imaging device further including a fill light section, in which the fill light section emits light in response to an operation by which the shutter button is pressed halfway.

(8) The imaging device described in any one of (1) to (7), in which the direction in which a light is projected is a direction in which a back face of the imaging section is located.

(9) The imaging device described in any one of (1) to (8), in which the direction in which a light is projected can be changed.

(10) The imaging device described in any one of (1) to (9), in which the light-emitting section can be moved in at least one of a perpendicular direction and a horizontal direction.

(11) The imaging device described in any one of (1) to (10), the imaging device further including a housing, in which the light-emitting section can be attached to and removed from the housing.

(12) The imaging device described in any one of (1) to (11), in which the light-emitting section is a light-emitting diode (LED).

(13) The imaging device described in any one of (1) to (12), further including a shape adjusting section, in which an optical image based on a light by light emission of the light-emitting section is adjusted by the shape adjusting section to have a predetermined shape.

(14) An imaging method in an imaging device, in which a light by light emission of a light-emitting section is projected in a direction which is different from an imaging direction of an imaging section, the light-emitting section emits light with first brightness in accordance with a first operation and a confirmation image obtained via the imaging section is displayed on a display section, and the light-emitting section emits light with second brightness whose level of brightness is higher than the first brightness in accordance with a second operation and an image is obtained via the imaging section nearly synchronously with the light emission.

(15) A light-emitting device that is incorporated into an imaging device or can be attached to and removed from the imaging device, the light-emitting device including a light-emitting section that emits light with first brightness in accordance with a first operation which is performed on the imaging device and emits light with second brightness whose level of brightness is higher than the first brightness in accordance with a second operation which is performed on the imaging device.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging device comprising:
an imaging section; and
a light-emitting section, wherein
an imaging direction of the imaging section and a direction in which a light is projected by light emission of the light-emitting section are different directions.

2. The imaging device according to claim 1, wherein
the light-emitting section emits light with first brightness or second brightness whose level of brightness is higher than the first brightness.

3. The imaging device according to claim 2, wherein
the light-emitting section emits light with the first brightness in accordance with a first operation and emits light with the second brightness in accordance with a second operation.

4. The imaging device according to claim 3, wherein
the first operation is an operation for setting a predetermined mode, and
the second operation is an operation for giving an instruction to perform imaging.

5. The imaging device according to claim 4, wherein
the predetermined mode is a catchlight photographing mode, and
the operation for giving an instruction to perform imaging is an operation by which a shutter button is pressed.

6. The imaging device according to claim 5, wherein
the light-emitting section is turned off in response to an operation by which the shutter button is pressed halfway during light emission with the first brightness.

7. The imaging device according to claim 5, further comprising:
a fill light section, wherein
the fill light section emits light in response to an operation by which the shutter button is pressed halfway.

8. The imaging device according to claim 1, wherein
the direction in which a light is projected is a direction in which a back face of the imaging section is located.

9. The imaging device according to claim 1, wherein
the direction in which a light is projected can be changed.

10. The imaging device according to claim 1, wherein
the light-emitting section can be moved in at least one of a perpendicular direction and a horizontal direction.

11. The imaging device according to claim 1, further comprising:
a housing, wherein
the light-emitting section can be attached to and removed from the housing.

12. The imaging device according to claim 1, wherein
the light-emitting section is a light-emitting diode (LED).

13. The imaging device according to claim 1, further comprising:
a shape adjusting section, wherein
an optical image based on a light by light emission of the light-emitting section is adjusted by the shape adjusting section to have a predetermined shape.

14. An imaging method in an imaging device, wherein
a light by light emission of a light-emitting section is projected in a direction which is different from an imaging direction of an imaging section,
the light-emitting section emits light with first brightness in accordance with a first operation and a confirmation image obtained via the imaging section is displayed on a display section, and
the light-emitting section emits light with second brightness whose level of brightness is higher than the first brightness in accordance with a second operation and an image is obtained via the imaging section nearly synchronously with the light emission.

15. A light-emitting device that is incorporated into an imaging device or can be attached to and removed from the imaging device, the light-emitting device comprising:
a light-emitting section that emits light with first brightness in accordance with a first operation which is performed on the imaging device and emits light with second brightness whose level of brightness is higher than the first brightness in accordance with a second operation which is performed on the imaging device.
